(19) United States
(12) Patent Application Publication
(10) Pub. No.: US 2012/0201151 A1
(43) Pub. Date: Aug. 9, 2012

(54) Layer 2 ACK And NACK Status Reporting

(75) Inventor: Keiichi Kubota, Weybridge (GB)

(73) Assignee: Renesas Mobile Corporation

(21) Appl. No.: 13/022,939

(22) Filed: Feb. 8, 2011

(51) Int. Cl. H04W 24/00

(52) U.S. Cl. 370/252

(57) ABSTRACT

A second timer is started upon sending a negative acknowledge status indicator. Sending of negative acknowledge status indicators is inhibited while the second timer is running, and un-inhibited/resumed upon expiry of the second timer. A first timer is started upon sending an acknowledge status indicator. Sending of acknowledge status indicators is inhibited while the first timer is running, and un-inhibited/resumed upon expiry of the first timer. The timer durations may be related but operation of the first timer and the second timer is independent of one another. In a specific example the first timer is an ACK status prohibit timer, the second timer is a NACK status prohibit timer, the acknowledge status indicator is a status PDU with ACK super-field, and the negative acknowledge status indicator is a status PDU with List, Bitmap, Relative List super-field.

### TECHNICAL FIELD

The exemplary and non-limiting embodiments of this invention relate generally to wireless communication systems, methods, devices and computer programs and, more specifically, relate to improving data rates by changing how acknowledgement/negative acknowledgement status is reported.

### BACKGROUND

The following abbreviations that may be found in the specification and/or the drawing figures are defined as follows:

3GPP third generation partnership project

ACK acknowledge

ARQ automatic repeat request

DL downlink (node B towards UE)

HSDPA high speed downlink packet access

MAC medium access control

MIMO multiple input multiple output

NACK negative ACK

Node B base station/access node in an HSDPA system

PDU protocol data unit

RLC radio link control

RNC radio network controller

RRC radio resource control

RTT round trip time

SDU service data unit

TCP/IP transmission control protocol/internet protocol

UE user equipment

UL uplink (UE towards node B)

UMTS universal mobile telecommunications system

UTRAN UMTS terrestrial radio access network

The HSDPA system provides high speed downlink access from a UMTS base station (Node B) under control of a RNC to a plurality of user entities via the MAC-hs layer (layer 1). The RLC (layer 2) operates above the MAC-hs protocol in the protocol stack and provides connection to upper communication layers such as TCP/IP, both in the user entity and the RNC. Both the RLC protocol and the MAC-hs protocol are ARQ protocols featuring retransmissions of incorrectly received protocol data units.

The RLC protocol for the 3GPP standard is specified in TS 25.322. The RLC layer in 3GPP can operate in three modes, transparent mode, unacknowledged mode and acknowledged mode (AM). The AM mode is most relevant for these teachings. In the AM mode, incorrectly received PDUs discovered by the receiving side are retransmitted by the transmitting side by means of the ARQ protocol mentioned above.

An AM RLC entity consists of a transmitting side which transmits RLC PDUs, and a receiving side which receives RLC PDUs. FIG. 1 is a schematic diagram of an AM RLC entity, reproduced from FIG. 4 of WO2005/034418. The AM RLC entity resides in the UE and in the RNC, respectively. The transmitting side segments and/or concatenates RLC SDUs into RLC PDUs. The receiving side reassembles received PDUs into RLC SDUs and transmits these to higher data layers. SDUs are also received from the layer above the RLC layer. In AM mode, the RLC layer is responsible for the delivery of SDUs in consecutive order. The AM RLC entity is used for non-real time data transfer which requires reliability, for example signaling and TCP/IP. Therefore it is used for high speed data transfer, such as FTP download and HTTP download (file transfer protocol and hypertext transfer protocol, respectively).

For UMTS, work items have been introduced for data rate improvements in Release 10 and Release 11. Since these releases are to include multi-cell HSDPA and MIMO operation, data rate improvement is vital. In current 3GPP specifications the AM RLC has one network configurable timer which is termed a status prohibit timer, defined at section 9.5 f) of 3GPP TS 25.322 v10.0.0 (2012 December). The status prohibit timer is used to prevent the transmitter RLC from receiving too many status reports from the receiver RLC entity by controlling how often the receiver RLC can report the ACK/NACK status to the transmitter RLC.

Teachings herein relate to improving data rate with relevance to that timing process in the RLC entity.

### SUMMARY

In a first exemplary embodiment of the invention there is an apparatus comprising at least one processor and at least one memory storing a computer program. In this embodiment the at least one memory with the computer program is configured with the at least one processor to cause the apparatus to at least: upon sending a negative acknowledge status indicator, start a timer and inhibit sending negative acknowledge status indicators while the timer is running; and upon expiry of the timer, un-inhibit sending negative acknowledge status indicators.

In a second exemplary embodiment of the invention there is a method comprising: upon sending a negative acknowledge status indicator, starting a timer and inhibiting sending negative acknowledge status indicators while the timer is running; and upon expiry of the timer, un-inhibiting sending negative acknowledge status indicators.

In a third exemplary embodiment of the invention there is a computer readable memory storing a computer program, in which the computer program comprises: code for, upon sending a negative acknowledge status indicator, starting a timer and inhibiting sending negative acknowledge status indicators while the timer is running; and code for, upon expiry of the timer, un-inhibiting sending negative acknowledge status indicators.

In a fourth exemplary embodiment of the invention there is an apparatus comprising first and second control means. The first control means is for inhibiting sending of negative acknowledge status indicators for a duration which begins upon sending a negative acknowledge status indicator. The second control means is for resuming sending negative acknowledge status indicators upon expiry of the duration. By example the first and second control means may be embodied as a NACK status prohibit timer, and/or a processor running stored software to implement the inhibiting and resuming with reference to the NACK status prohibit timer.

In a more particular embodiment of the apparatus immediately above, the apparatus further comprises third and fourth control means. In this particular embodiment the third control means is for inhibiting sending of acknowledge status indicators for a duration which begins upon sending an acknowledge status indicator; and the fourth control means is for resuming sending of acknowledge status indicators upon expiry of the duration. By example the third and fourth control means may be embodied as an ACK status prohibit timer, and/or a processor running stored software to implement the inhibiting and resuming with reference to the ACK status prohibit timer.

These and other embodiments and aspects are detailed below with particularity.

### BRIEF DESCRIPTION OF THE DRAWINGS

FIG. 1 is reproduced from FIG. 4 of WO2005/034418 illustrating a schematic diagram of an acknowledged mode (AM) entity in a RNC which transmits RLC PDUs.

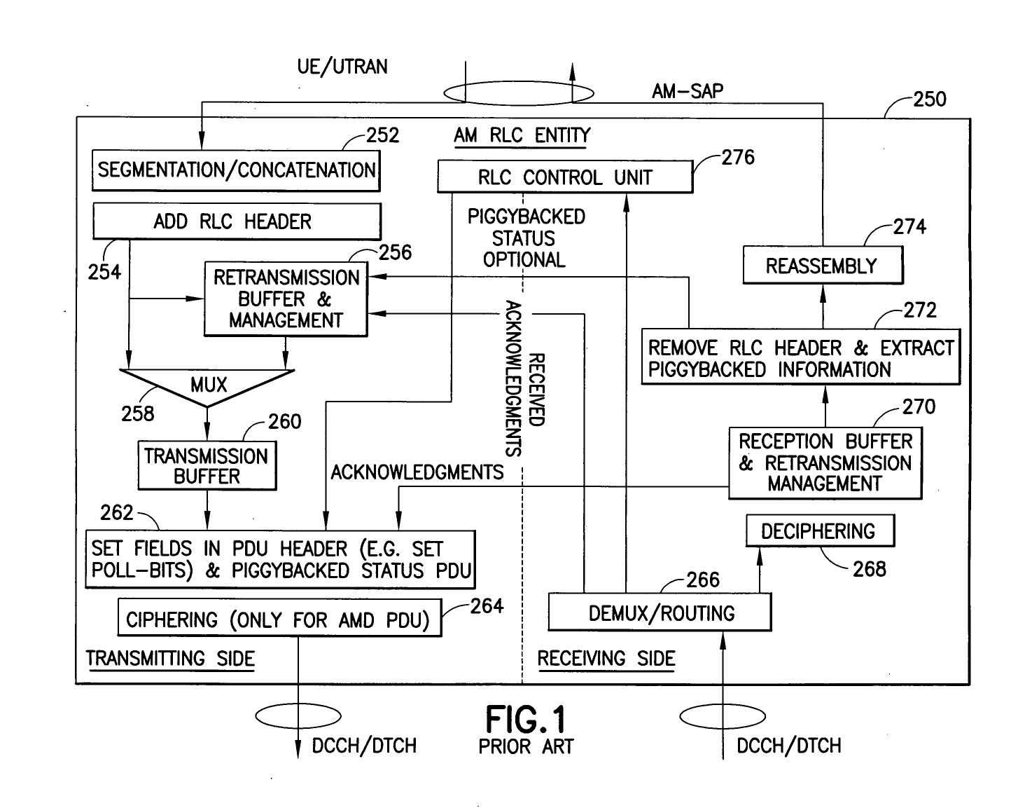

FIG. 2 is a simplified block diagram of an RLC entity adapted according to the exemplary embodiments detailed herein.

FIG. 3 is a logic flow diagram that illustrates the operation of a method, and a result of execution of computer program instructions embodied on a computer readable memory, in accordance with the exemplary embodiments of this invention.

FIG. 4 is a simplified block diagram of a UE in communication with a radio network controller RNC via a Node B, and illustrates exemplary electronic devices suitable for use in practicing exemplary embodiments of this invention.

### DETAILED DESCRIPTION

Consider the status prohibit timer noted in the background section above; it is defined to control how often the receiver RLC can report the ACK and NACK status to the transmitter RLC, but there is only one timer the network can configure for controlling how frequent both ACK and NACK is reported. One timer simultaneously controls both ACK and NACK reporting from the same RLC entity.

From the transmitter point of view, it may be better that the receiver sends back an ACK status as soon as possible, preferably less than the round trip time RTT, so that the transmitter can update the transmission window. But data transmission is generally reliable, and so the transmitter does not expect to receive a NACK status very often (for example, less than the RTT). Also, reporting NACK status too frequently tends toward redundant data re-transmissions which wastes bandwidth and consequently reduces data throughput. The inventor has considered that at least one part of the problem is that the current arrangement for the status prohibit timer disallows, for the same time interval, the receiver from sending both ACK status reports and NACK status reports. So merely adjusting the timer duration has quite limited effect in optimizing the data throughput.

According to an exemplary embodiment, instead of a status prohibit timer controlling how frequent both ACK and NACK responses may be sent by an RLC entity, there are two status prohibit timers of which one is for ACK status reporting and the other is for NACK status reporting. In these exemplary embodiments there is also RRC signaling for setting/controlling the status prohibit timers.

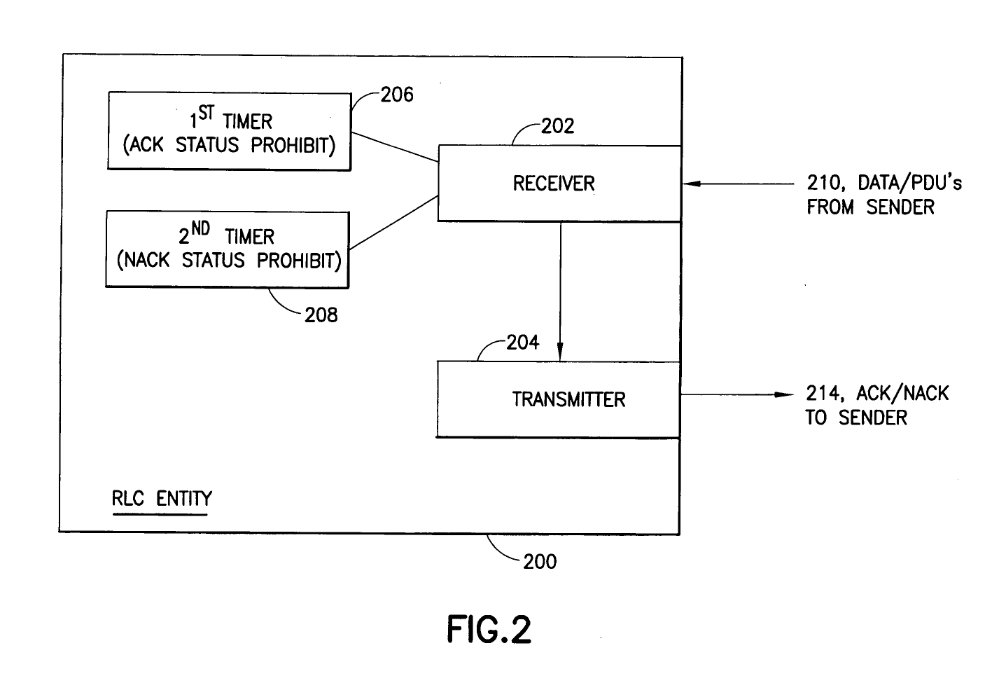

Consider the RLC entity 200 shown by the simplified block diagram of FIG. 2. Such an RLC entity 200 may reside in the UE or in the RNC as noted above. There is a receiver 202 which receives data/PDUs from a sender 210 and in reply the transmitter 204 sends ACK and NACK status reports 214 to the sender of those data/PDUs. Within the RLC entity 200 there is also a first timer 206 denoted as an ACK status prohibit timer and a second timer 208 denoted as a NACK status prohibit timer. Both timers 206, 208 control the transmitting of the ACKs/NACKs 214 to the sender of the data being ACK'd/NACK'd.

The timers operate to control the RLC entity 200/RLC receiver entity 202 as follows. The receiver RLC 202 is configured with the ACK status prohibit timer 206 which starts when the RLC entity 200 sends an ACK status report 214 to the sender of the data being ACK'd. The RLC entity 200 is prohibited from transmitting/sending any ACK status reports 214 while the ACK status prohibit timer 206 is still running. After expiry of the timer 206 (the duration kept by the ACK status timer), the RLC entity 200 can again transmit an ACK status report 214 to the sender of the data being ACK'd.

The receiver RLC 202 is also configured with the NACK status prohibit timer 208, which starts when the RLC entity 200 sends a NACK status report 214 to the sender of the data being NACK'd. The RLC entity 200 is prohibited from transmitting/sending any NACK status reports 214 while in the NACK status prohibit timer is still running. After expiry of the timer 208 (the duration kept by the NACK status timer), the RLC entity 200 can again transmit a NACK status report 214 to the sender of the data being NACK'd. Note that while reference number 212 at FIG. 2 refers to both the ACK and NACK status reports, the ACK and NACK status reports are distinct from one another. In an exemplary embodiment the status prohibit timers 206, 208 control transmission of the ACK and NACK status reports from the receiver 202 to the transmitter 204 within the same RLC entity 200. This prevents the transmitter 204 from learning that there is an ACK or NACK to send while the associated timer is running, and so the end result is the same; controlling the ACK/NACK messages 214 sent from the RLC entity 200.

For implementations in which the RLC entity 200 is disposed within the UE, the timer durations kept by the respective ACK status timer 206 and by the NACK status timer 208 are received at the UE in signaling sent from the wireless network as respective ACK and NACK status timer configurations. These two distinct timer configurations may both be signaled to the UE within the same message or in different signaled messages, or in an embodiment detailed below only the NACK timer duration is explicitly signaled by the network.

Two examples are presented for illustrating exemplary but non-limiting embodiments of the invention.

In a first example the network signals the ACK and NACK timer configurations in a single message. By example the network sends the configurations (timer durations) for the ACK status prohibit timer 206 and for the NACK status prohibit timer 208 via an RRC message, such as for example any one or more of the following:
RRConnectionSetup message
RadioBearerSetup message
RadioBearerReconfiguration message
RadioBearerRelease message
CellUpdateConfirm message
HandoverToUTRANCommand message.

Still in this first example the receiver 202 AM RLC entity 200 implements the two status prohibit timers as follows. For the ACK status prohibit timer, the receiver RLC 202 starts the ACK status prohibit timer 206 when the RLC entity 200 sends an ACK status PDU 214 and stops/inhibits sending any ACK status PDU while that timer 206 is running. The RLC entity 200/receiver RLC 202 re-starts/un-inhibits its own transmission of ACK status PDUs after expiry of that timer 206. For the NACK status prohibit timer, the receiver RLC 202 starts the NACK status prohibit timer 208 when it sends a NACK status PDU 214, and stops/inhibits sending any NACK status PDU while that timer 208 is running. The RLC entity 200/receiver RLC 202 re-starts/un-inhibits its own transmission of NACK status PDUs after expiry of that timer 208.

The term ACK status PDU itself is not used in 3GPP specifically, but instead the 3GPP terminology is status PDU with ACK super-field. There is no pre-existing NACK status PDU in conventional 3GPP but a status PDU with List, Bitmap, Relative List super-field can be used for this purpose.

There are additional status PDUs including window, MRW ACK, and MRW superfield to name a few. In one exemplary embodiment timing for sending these status PDUs is independent of both the ACK and NACK status prohibit timers 206, 208. In another exemplary embodiment the sending of one or more of these other status PDUs is controlled by the NACK status prohibit timer 208, and/or by the ACK status prohibit timer 206.

In a second example the network signals only the NACK timer configuration and does not explicitly signal the ACK timer configuration. In this example the network signals one timer status prohibit configuration via an RRC message, and that configuration indicates the duration of the NACK status prohibit timer 208. By example this RRC message may be any of those listed in the first example above. The UE internally calculates the duration of the ACK status prohibit timer 206 by using a predefined offset/coefficient to the NACK status prohibit timer duration. By example the predetermined offset/coefficient may be published in a wireless standard (e.g., 3GPP TS series) and thus stored in the UE as firmware. Alternatively the offset/coefficient is configurable by the network and the network signals to the UE the offset/coefficient for the NACK status prohibit timer duration which the network itself selects. In an exemplary embodiment the network signals the network-configured offset in a same RRC message with the NACK status prohibit timer configuration. Implementing the timers is similar to that detailed above for the first example.

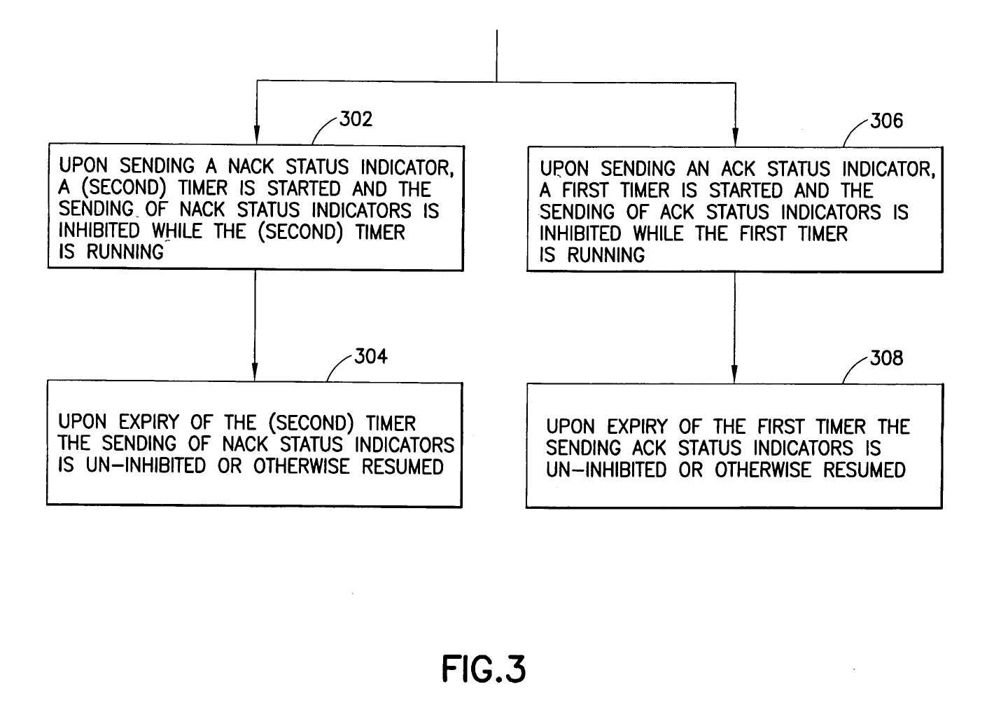

FIG. 3 is a logic flow diagram which describes these exemplary embodiments of the invention in a manner which may be from the perspective of the UE or of the RNC in the network since the network also has an RLC entity. FIG. 3 may be considered to illustrate the operation of a method, and a result of execution of a program of computer instructions stored in a computer readable memory, and a specific manner in which components of an electronic device are configured to cause that electronic device to operate. The various blocks shown in FIG. 3 may also be considered as a plurality of coupled logic circuit elements constructed to carry out the associated function(s), or specific result of strings of computer program code stored in a memory.

At block 302, upon sending a negative acknowledge status indicator, a timer is started and the sending of negative acknowledge status indicators is inhibited while the timer is running. At block 304, upon expiry of the timer the sending of negative acknowledge status indicators is un-inhibited or otherwise resumed. Further blocks of FIG. 3 are specific to various of the above non-limiting exemplary embodiments.

For blocks 306 and 308, consider that the timer of blocks 302 and 304 is a second timer. In this case then at block 306, upon sending an acknowledge status indicator, a first timer is started and the sending of acknowledge status indicators is inhibited while the first timer is running. And at block 308, upon expiry of the first timer the sending of acknowledge status indicators is un-inhibited or otherwise resumed. While the timer durations may be related, operation of the first timer and the second timer is independent of one another. The periods during which the different status PDUs are inhibited may or may not overlap in any given instance.

As noted in the detailed examples above, the first timer may be an ACK status prohibit timer, the second timer may be a NACK status prohibit timer, the acknowledge status indicator may be an ACK status protocol data unit (or in 3GPP terminology a status PDU with ACK super-field), and the negative acknowledge status indicator may be a NACK status protocol data unit (or in 3GPP terminology a status PDU with List, Bitmap, Relative List super-field).

The method and apparatus executing it represented by FIG. 3 may be a radio link control RLC entity, and a duration between the start of the second timer at block 302 and expiry of the second timer at block 304 is signaled in RRC signaling. For the case such an RLC is disposed in or otherwise embodied as a UE, the various embodiments above detail that: the UE can receive in RRC signaling a first duration between the start of the first timer at block 306 and expiry of the first timer at block 308; or the UE can compute the first duration between the start of the first timer at block 306 and expiry of the first timer at block 308 by offsetting from the second duration by an offset which the UE receives via signaling or which is stored in a local memory of the UE and defined in a wireless standard. In another embodiment the UE computes the second timer duration based on the first timer duration. For the case such an RLC entity is disposed within a node of a wireless network such as the RNC, it is this network which signals the duration to the UE.

Embodiments of the invention may be implemented as an apparatus which has first and second control means. The first control means is for inhibiting sending of negative acknowledge status indicators for a duration which begins upon sending a negative acknowledge status indicator; and the second control means is for resuming sending negative acknowledge status indicators upon expiry of the duration. By example the first control means may be a control signal which indicates that the NACK status prohibit timer is running and which is sent from or read from the NACK status prohibit timer upon start of the NACK status prohibit timer; and the second control means may be a control signal which indicates that the NACK status prohibit timer is no longer running and which is sent from or read from the NACK status prohibit timer upon expiry of the duration.

Similar can be said if it is considered the apparatus further includes third and fourth control means. In this case the third control means is for inhibiting the sending of acknowledge status indicators for a duration which begins upon sending an acknowledge status indicator; and the fourth control means is for resuming the sending of acknowledge status indicators upon expiry of the duration. By example the third control means may be a control signal which indicates that the ACK status prohibit timer is running and which is sent from or read from the ACK status prohibit timer upon start of the ACK status prohibit timer; and the fourth control means may be a control signal which indicates that the ACK status prohibit timer is running and which is sent from or read from the ACK status prohibit timer upon expiry of the duration.

The blocks of FIG. 3 and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

One technical effect and advantage of these exemplary embodiments is that the receiver RLC can transmit its ACK status report more frequently than the prior art arrangement, without impacting the transmitter's retransmission activities. The technical effect is that there is less possibility that the transmitter RLC's transmission window becomes full because the window is flushed more frequently.

In conventional practice the (single) status prohibit timer duration causes a bottleneck of the data throughput. Mathematically, the constraint might be expressed as “maximum RLC throughput=(RLC PDU size*RLC window size/(RTT+status prohibit timer duration/2)”, which was used for the theoretical maximum RLC throughput calculation in 3GPP. Applying the exemplary embodiments as detailed above effectively removes the “status prohibit timer duration” from the above formula.

For example, applying the maximum RLC PDU size (12000 bits), maximum window size (2048), a practical RRT (70 ms), and a practical status prohibit timer configuration (40 ms) to the above throughput formula, the resulting maximum RLC throughput is 260 Mbps. This is not considered fast enough to support the Release 11 8C-HSDPA physical layer theoretical maximum throughput of 336 Mbps. But applying the exemplary embodiments above for the RLC entity, then the maximum RLC throughput becomes 334 Mbps, a 28% improvement over the conventional timer design and also very close to the Release 11 8C-HSDPA Physical layer theoretical maximum throughput.

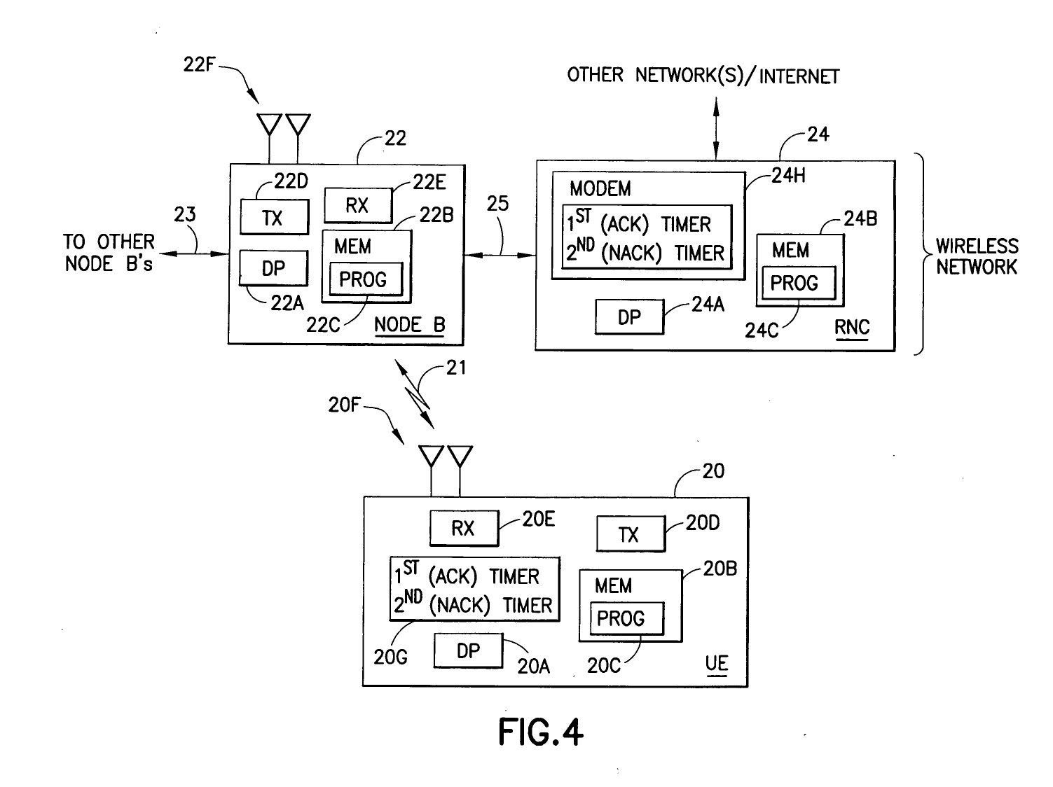

Reference is now made to FIG. 4 for illustrating a simplified block diagram of various electronic devices and apparatus that are suitable for use in practicing the exemplary embodiments of this invention. In FIG. 4 a wireless network (node B 22 and RNC 24) is adapted for communication over a wireless link 21 with an apparatus, such as a mobile terminal or UE 20, via a network access node, such as a base or relay station or more specifically a node B 22. The network may include a node (e.g., the RNC 24) which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the node B 22 via one or more antennas 20F. Also stored in the MEM 20B is the timer configuration(s) which the UE 20 utilizes to implement the first and second timers 206, 208 which are shown in FIG. 4 as reference number 20G.

The node B 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. There is a data and/or control path 25 coupling the node B 22 with the RNC 24, and another data and/or control path 23 coupling the node B 22 to other node B's/access nodes.

The RLC entity in the RNC 24 also stores the configuration(s) to implement the first and second timers 206, 208. Similarly, the RNC 24 includes processing means such as at least one data processor (DP) 24A, storing means such as at least one computer-readable memory (MEM) 24B storing at least one computer program (PROG) 24C, and communicating means such as a modem 24H for bidirectional wireless communications with the Node B 22 via the data/control path 25. While not particularly illustrated for the UE 20 or node B 22, those devices are also assumed to include as part of their wireless communicating means a modem which may be inbuilt on an RF front end chip within those devices 20, 22 and which also carries the TX 20D/22D and the RX 20E/22E.

At least one of the PROGs 20C in the UE 20 is assumed to include program instructions that, when executed by the associated DP 20A, enable the device to operate in accordance with the exemplary embodiments of this invention, as detailed above. The UE 20 and the RNC 24 may also have software to implement certain aspects of these teachings for implementing the ACK and NACK status prohibit timers. In these regards the exemplary embodiments of this invention may be implemented at least in part by computer software stored on the MEM 20B, 22B which is executable by the DP 20A of the UE 20 and/or by the DP 24A of the RNC 24, or by hardware, or by a combination of tangibly stored software and hardware (and tangibly stored firmware). Electronic devices implementing these aspects of the invention need not be the entire UE 20 or RNC 24, but exemplary embodiments may be implemented by one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances. Exemplary embodiments of these teachings may be within such a UE, or one or more components thereof such as for example a USB dongle or a data card.

Various embodiments of the computer readable MEMs 20B, 22B and 24B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A and 24A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the UTRAN system, it should be appreciated that the exemplary embodiments of this invention are not limited for use with only this one particular type of wireless communication system, and that they may be used to advantage in other wireless communication systems such as for example E-UTRAN, GERAN and others so long as there are both ACK and NACK status messages sent from a same radio link layer entity.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory storing a computer program;
in which the at least one memory with the computer program is configured with the at least one processor to cause the apparatus to at least:
upon sending a negative acknowledge status indicator, start a timer and inhibit sending negative acknowledge status indicators while the timer is running; and
upon expiry of the timer, un-inhibit sending negative acknowledge status indicators.

2. The apparatus according to claim 1, in which the timer is a second timer, and wherein the at least one memory with the computer program is configured with the at least one processor to cause the apparatus to at least further:
upon sending an acknowledge status indicator, start a first timer and inhibit sending acknowledge status indicators while the first timer is running; and
upon expiry of the first timer, un-inhibit sending acknowledge status indicators.

3. The apparatus according to claim 2, in which the first timer is an ACK status prohibit timer, the second timer is a NACK status prohibit timer, the acknowledge status indicator is a status protocol data unit including an ACK super-field, and the negative acknowledge status indicator is a status protocol data unit including a List, Bitmap, Relative List super-field.

4. The apparatus according to claim 2, in which the apparatus comprises a receiver radio link control entity and a duration between the start of the second timer and expiry of the second timer is signaled in radio resource control signaling.

5. The apparatus according to claim 4, in which the receiver radio link control entity is disposed within a user equipment which receives the duration.

6. The apparatus according to claim 5, in which the duration is a second duration, and the user equipment further receives in radio resource control signaling a first duration between the start of the first timer and expiry of the first timer.

7. The apparatus according to claim 5, in which the duration is a second duration, and the user equipment computes a first duration between the start of the first timer and expiry of the first timer by offsetting from the second duration by an offset which the user equipment receives via signaling.

8. The apparatus according to claim 5, in which the duration is a second duration, and the user equipment computes a first duration between the start of the first timer and expiry of the first timer by offsetting from the second duration by an offset which is stored in a local memory of the user equipment and defined in a wireless standard.

9. The apparatus according to claim 4, in which the receiver radio link control entity is disposed within a node of a wireless network which signals the duration.

10. The apparatus according to claim 2, in which the apparatus computes a duration between the start of the second timer and expiry of the second timer based on the duration of the first timer.

11. A method comprising:
upon sending a negative acknowledge status indicator, starting a timer and inhibiting sending negative acknowledge status indicators while the timer is running; and
upon expiry of the timer, un-inhibiting sending negative acknowledge status indicators.

12. The method according to claim 11, in which the timer is a second timer and the method further comprises:
upon sending an acknowledge status indicator, starting a first timer and inhibiting sending acknowledge status indicators while the first timer is running; and
upon expiry of the first timer, un-inhibiting sending acknowledge status indicators.

13. The method according to claim 12, in which the first timer is an ACK status prohibit timer, the second timer is a NACK status prohibit timer, the acknowledge status indicator is a status protocol data unit including an ACK super-field, and the negative acknowledge status indicator is a status protocol data unit including a List, Bitmap, Relative List super-field.

14. The method according to claim 12, in which the method is executed by a radio link control entity, and a duration between the start of the second timer and expiry of the second timer is signaled in radio resource control signaling.

15. The method according to claim 14, in which the radio link control entity is disposed within a user equipment which receives the duration which is a second duration, the method further comprising at least one of:
the user equipment receiving in radio resource control signaling a first duration between the start of the first timer and expiry of the first timer;
the user equipment computing a first duration between the start of the first timer and expiry of the first timer by offsetting from the second duration by an offset which the user equipment receives via signaling; and
the user equipment computing a first duration between the start of the first timer and expiry of the first timer by offsetting from the second duration by an offset which is stored in a local memory of the user equipment and defined in a wireless standard.

16. The method according to claim 14, in which the radio link control entity is disposed within a node of a wireless network which signals the duration.

17. A computer readable memory storing a computer program comprising:
code for, upon sending a negative acknowledge status indicator, starting a timer and inhibiting sending negative acknowledge status indicators while the timer is running; and
code for, upon expiry of the timer, un-inhibiting sending negative acknowledge status indicators.

18. The computer readable memory according to claim 17, which the timer is a second timer and the memory further comprising:
code for, upon sending an acknowledge status indicator, starting a first timer and inhibiting sending acknowledge status indicators while the first timer is running; and
code for, upon expiry of the first timer, un-inhibiting sending acknowledge status indicators.

19. The computer readable memory according to claim 18, in which the first timer is an ACK status prohibit timer, the second timer is a NACK status prohibit timer, the acknowledge status indicator is a status protocol data unit including an ACK super-field, and the negative acknowledge status indicator is a status protocol data unit including a List, Bitmap, Relative List super-field.

20-21. (canceled)
